(19) United States
(12) Patent Application Publication
(10) Pub. No.: US 2014/0272050 A1
(43) Pub. Date: Sep. 18, 2014

(54) Food cooking

(71) Applicant: Haim Shelemey, London (GB)

(72) Inventor: Haim Shelemey, London (GB)

(21) Appl. No.: 14/202,666

(22) Filed: Apr. 15, 2014

(51) Int. Cl. A47J 37/12; A23L 1/01

(52) U.S. Cl. CPC A47J 37/1214; A23L 1/0107
USPC 426/438; 99/404

(57) ABSTRACT

A food cooker comprises a reservoir 5 for containing a heated cooking liquid 10 such as fat or oil. Foodstuff 60 is held between two spaced apart conveyor belts 15, 20 which move in opposite directions to draw the foodstuff through the cooking liquid. The conveyor belts 15, 20 are loose on their respective supports 25, 30, 35, 40 such that they hang downwards under their weight. This creates a curved path through the reservoir 5, increasing the distance traveled by foodstuff 60 relative to a straight path, thus reducing the size of reservoir needed for a given cooking time and speed of movement of the foodstuff 60. The loose hanging of the conveyor belts also holds the foodstuff gently, preventing damage or crushing of delicate foodstuff such as falafel balls 60.

### BACKGROUND OF THE INVENTION

The present invention relates to a device and method for cooking food by submerging it in a hot liquid such as fat or oil.

Deep fat frying is a popular method of cooking a wide range of foodstuffs. Chips or fries, doughnuts, particulate food such as falafel, battered fish or other meat products, and vegetables are just some of the possibilities.

One cooking method involves placing the foodstuff in a basket and submerging the basket in a heated vat of fat or oil until the food is cooked. This has the advantage of being straightforward, but placing a large amount of food together in a single clump can lead to uneven cooking and reduced crispiness as the fat at the centre of the clump is cooled by the surrounding food.

To obtain more even cooking, a variety of cookers using conveyor belts have been developed which move the food through the fat while it is being cooked. One example of a conveyor belt cooker is WO-A-87/06811 which boils shrimp by pushing them through a reservoir with division plates spaced along an endless, perforated conveyor belt. Another example is U.S. Pat. No. 4,228,730 which cooks frozen French fries in a similar manner.

These devices take up significant space in a kitchen as they require a long reservoir through which the food can be moved in a straight line. They are also only suitable for solid foodstuffs which are not liable to breaking apart as they are pushed and dragged through the fat. Particulate foodstuff, such as falafel or meatballs, is very brittle and liable to break apart before it is cooked. What is needed is a more compact cooker which submerges and moves food through a reservoir of heated liquid in a more delicate manner.

### BRIEF SUMMARY OF THE INVENTION

One aspect of the present invention provides a food cooker comprising a reservoir suitable for being filled with a heated cooking liquid to a liquid level, and a drum for delivering foodstuff into the reservoir, the drum comprising: a plurality of laterally spaced apart holes, the drum being rotatable such that, as the drum rotates in use, foodstuff contained within the drum falls out of the bottom of the drum through the holes into the reservoir; and the reservoir comprising: a first conveyor belt movable in a first direction; and a second conveyor belt movable in a second direction opposite to the first direction; the first and second conveyor belts being spaced apart to define a path between them at least part of which passes beneath the liquid level, the path being sized to receive foodstuff and the opposing movements of the conveyor belts for drawing the foodstuff along the path through the heated cooking liquid in the reservoir in use; wherein both the spacing between the laterally spaced apart holes and the speed of rotation of the drum are sufficient to ensure that, in use, a gap between adjacent pieces of foodstuff is sufficient to prevent significant local cooling of the heated cooking liquid as the foodstuff is drawn through the heated cooking liquid in the reservoir.

By providing two conveyor belts moving in contrary directions, the foodstuff is not dragged against a stationary surface but is carried gently through the cooking liquid. Delicate or particulate foodstuffs are therefore not damaged. The foodstuff is also not at risk of being crushed or broken by direct impact of the division plates of the above-mentioned prior art. Also, the foodstuff is held under the cooking liquid, preventing it from floating to the surface such that turning is not required during the cooking process. Additionally, the foodstuff is dropped into the cooking liquid from a rotating drum with spaced apart holes to ensure the foodstuff is spaced apart during cooking.

Preferably, first conveyor belt forms a first curve and the second conveyor belt forms a second curve, the first and second curves corresponding with one another and forming a curved path along which foodstuff is drawn in use. Advantageously, this creates a continuously curving path through the reservoir, increasing the distance traveled by the foodstuff relative to a straight path, thus reducing the length of reservoir needed for a given cooking time and speed of movement of the foodstuff.

Preferably, the first conveyor belt is an endless conveyor belt and the first curve is created by a lower portion of the first conveyor belt hanging down under its own weight, and wherein the second conveyor belt is an endless conveyor belt and the second curve is created by an upper portion of the second conveyor belt hanging down under its own weight. The loose hanging of the conveyor belts also holds the foodstuff gently, further preventing damage or crushing.

Preferably, at least a portion of each of the first and second conveyor belts which define the path are pliable. As the portions of the conveyor belts which define the path are pliable, it further ensures that the foodstuff is not crushed.

Another aspect of the present invention provides a method of cooking food comprising: rotating a drum having a plurality of laterally spaced apart holes such that, as the drum rotates, foodstuff contained within the drum falls out of the bottom of the drum through the holes into the reservoir; receiving the foodstuff between two spaced apart, pliable conveyor belts moving in opposite directions and defining a path between them sized to receive the foodstuff; and drawing the foodstuff in a curved path through the cooking liquid using the conveyor belts, the foodstuff being submerged under the heated cooking liquid for at least part of the path; wherein both the spacing between the laterally spaced apart holes and the speed of rotation of the drum are sufficient to ensure that a gap between adjacent pieces of foodstuff is sufficient to prevent significant local cooling of the heated cooking liquid as the foodstuff is drawn through the heated cooking liquid in the reservoir.

### BRIEF DESCRIPTION OF THE SEVERAL VIEWS OF THE DRAWINGS

Preferred embodiments of the present invention will now be described by way of an example and with reference to the accompanying drawings in which:

FIG. 1 is a side section view through a cooker reservoir;

FIG. 2 is a perspective view of the cooker reservoir with one side of the reservoir removed; and

FIG. 3 is a perspective view of a cooker embodying the present invention.

### DETAILED DESCRIPTION OF THE INVENTION

FIGS. 1 and 2 show a cooker reservoir 5 containing a cooking liquid 10 such as fat, oil or water. The cooking liquid is heated by, for example, gas burners or electrical elements 105 (illustrated in FIG. 3) typically positioned below the reservoir 5. Two endless conveyor belts, forming an upper conveyor 15 and a lower conveyor 20, are positioned inside the reservoir 5. The conveyor belts are made from any suitable material such as a light, perforated belt, or an array of interconnected, thin, parallel metal bars, as indicated in FIG. 2.

The upper conveyor 15 is carried by two rotatable supports. An upper driven support 25 is driven by a motor (not shown) and causes the upper conveyor 15 to move. An upper free support 30 either rotates freely or otherwise allows the upper conveyor 15 to pass freely over it as the upper conveyor 15 moves. The lower conveyor 20 is also carried by two supports, a lower driven support 35 which is driven by a motor (not shown) and causes the lower conveyor 20 to move, and a lower free support 40 which either rotates freely or otherwise allows the lower conveyor 20 to pass freely over it as the lower conveyor 20 moves. From the perspective of FIGS. 1 and 2, the upper driven support 25 is driven to rotate clockwise in use, to carry the upper conveyor 15 in a clockwise direction. The lower driven support 35 is driven in the opposite direction to the upper driven support 25, anti-clockwise from the perspective of FIGS. 1 and 2, to drive the lower conveyor 20 in an anti-clockwise direction at the same speed as the upper conveyer 15.

Each of the conveyor belts is looped loosely around its respective supports rather than being pulled taut. Consequently, each belt is pliable and falls or droops slightly under its weight. A top portion of the belt of the upper conveyor 15 is supported by a strut 45 positioned approximately midway between the upper driven support 25 and the upper free support 30. Additional support struts may be included as necessary depending upon the size and weight of the conveyor belt. However, a bottom portion of the belt of the upper conveyor 15 is not supported along its length between the upper driven support 25 and the upper free support 30, and therefore hangs downwards in a curve. The top portion is kept taut and the bottom portion allowed to hang down also by virtue of the upper driven support 25 pulling the upper conveyor 15 from the top portion and round to the bottom portion.

Similarly, an unsupported top portion of the lower conveyor 20 hangs downwards in a curve but a bottom portion is supported by two or more struts 50, 55 along the length of the lower conveyor 20 between the lower driven support 35 and the lower free support 40. The top portion is allowed to hang and the bottom portion kept taut also by virtue of the lower driven support 35 pulling the upper conveyor 20 from the bottom portion and round to the top portion.

The upper conveyor 15 and lower conveyor 20 are spaced apart from one another so that a path is created between them. Specifically, a continuously curving path is defined by the curve formed by the hanging lower portion of the upper conveyor 15 and the corresponding curve formed by the hanging upper portion of the lower conveyor 20. At least part of the path runs under the surface of the heated cooking liquid 10. Foodstuff 60 dropped into the reservoir 5 at a first end enters the path and the motion of the conveyors draws the foodstuff 60 along the path, submerging it completely beneath the heated cooking liquid 10, to a second end of the reservoir 5 where the cooked foodstuff drops from the reservoir 5 into any suitable collector (not shown).

As a result of the path between the upper conveyor 15 and lower conveyor 20 being curved over the full length of the path, the distance traveled by the foodstuffs in traversing the length of the reservoir 5 is greater than a straight path through the reservoir 5. Consequently, for the same speed of movement of the foodstuff 60 through the reservoir 5, the cooking time while the foodstuff is submerged in the heated cooking liquid 10 is greater for a given size of reservoir 5. The reservoir 5 can therefore be smaller than would be necessary if the path were straight. Since cooking times for some foodstuffs can be several minutes, and these foodstuffs must be moved continuously through the heated cooking liquid 10 at a speed sufficient to avoid significant local cooling of the heated cooking liquid 10, there can be an appreciable reduction in size of reservoirs embodying the present invention compared to reservoirs which move foodstuffs through a predominantly straight path.

Since the portions of the two conveyors 15, 20 either side of the path through which the foodstuff 60 is drawn are pliable and hang loosely under their own weight, the foodstuff 60 is gripped between the two conveyors 15, 20 only lightly. Additionally, the supports 25, 30, 35, 40 of the two conveyors 15, 20 are not aligned with each other at the entrance and exit to the path so do not constrict the entrance/exit. Delicate and/or particulate foodstuffs such as falafel balls 60 are therefore not crushed, damaged or broken apart during the journey through the heated cooking liquid 10.

The location of the supports 25, 30, 35, 40 and the struts 45, 50, 55 can be adjusted to create paths of different sizes, changing the gap between the conveyors as desired. In this way, foodstuffs of different sizes and shapes can be cooked.

The upper and lower driven supports 25, 35 may be driven separately by independent motors. Preferably, however, as illustrated in FIG. 2, the driven supports 25, 35 are linked by a drive belt 65 and driven by a single motor. This saves space and ensures that the upper and lower conveyors 15, 20 move at the same speed. So that a single motor can drive the two conveyor belts 15, 20 in opposite directions, the drive belt 65 is looped around the upper and lower driven supports 25, 35 and two additional belt supports. A first belt support 70 above the driven supports 25, 35 and a second belt support 75 to the side of the driven supports 25, 35. In this way, the belt can pass around the inside of the upper driven support 25 and the outside of the lower driven support 35 so that when it is driven in the direction 80 indicated in FIG. 2, the conveyors are driven in opposite directions. The motor can be linked to any of the supports 25, 35, 70, 75 but preferably it is linked to the first belt support 70 which is positioned high enough above the driven supports 25, 35 to be above the level of the heated cooking liquid 10 in the reservoir 5 to prevent the cooking liquid from leaking out of the reservoir 5.

FIG. 3 shows a food cooking device 100 incorporating the reservoir 5 of FIGS. 1 and 2 described above. The food cooking device 100 further comprises a gas burner 105 for heating the cooking liquid 10, a foodstuff hopper 110 and a hollow rotatable drum 115 having one or more food-receiving holes 120. The hopper 110 is filled with suitable foodstuff 60. As the drum 115 is caused to rotate, the foodstuff 60 falls into the top of the drum 115 from the hopper 110 through the holes 120. As the drum 115 continues rotating the foodstuff 60 falls out the bottom of the drum 115 into the reservoir 5. The speed of rotation of the drum 110 can be adjusted to ensure a suitable gap between sequential pieces of foodstuff 60. Similarly, the holes 120 in the drum 115 are spaced apart sufficiently to prevent local cooling of the heated cooking liquid 10 between adjacent pieces of foodstuff 60.

Preferred embodiments of the present invention have been described by way of an example only. The skilled person will appreciate that variations to these embodiments can be made without departing from the scope of the claims.

1. A reservoir of a food cooker suitable for being filled with a heated cooking liquid to a liquid level, the reservoir comprising:
a first conveyor belt movable in a first direction; and
a second conveyor belt Movable in a second direction opposite to the first direction;
the first and second conveyor belts being spaced apart to define a oath between them at least part of which passes beneath the liquid level, the path being sized to receive foodstuff and the opposing movements of the conveyor belts for drawing the foodstuff along the path through the heated cooking liquid in the reservoir in use.

2. The reservoir of claim 1 wherein the first conveyor belt forms a first curve and the second conveyor belt forms a second curve, the first and second curves corresponding with one another and forming a curved path along which foodstuff is drawn in use.

3. The reservoir of claim 2 wherein the first conveyor belt is an endless conveyor belt and the first curve, is created by a lower portion of the first conveyor belt hanging down under its own weight, and wherein the second conveyor belt is an endless conveyor belt and the second curve is created by an upper portion of the second conveyor belt hanging down under its own weight.

4. The reservoir of any preceding claim wherein at least a portion of each of the first and second conveyor belts which define the path are pliable.

5. A food cooker comprising the reservoir of any preceding claim.

6. A method of cooking food comprising:
submerging the food in a heating cooking liquid; and
drawing the food in a curved path through the cooking liquid using two spaced apart, pliable conveyor belts moving in opposite directions and defining a path between them sized to receive the food.

7. A reservoir of a food cooker substantially as hereinbefore described with reference to the accompanying drawings.

8. A food cooker substantially as hereinbefore described with reference to the accompanying drawings.

9. A method of cooking food substantially as hereinbefore described with reference to the accompanying drawings.
